(19) United States
(12) Patent Application Publication
(10) Pub. No.: US 2011/0008508 A1
(43) Pub. Date: Jan. 13, 2011

(54) LOW CALORIE SYRUPS

(76) Inventors: Steven J. Catani, Athens, GA (US); Keith Sutter, Philadelphia, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/810,549

(22) PCT Filed: Dec. 19, 2008
(86) PCT No.: PCT/US08/87582

§ 371 Date: Sep. 21, 2010

Related U.S. Application Data
(60) Provisional application No. 61/016,927, filed on Dec. 27, 2007.

(51) Int. Cl. A23L 1/09; A23L 1/236; A23P 1/00

(52) U.S. Cl. 426/548; 426/658; 426/492

(57) ABSTRACT

A syrup composition comprising a natural syrup and a soluble food ingredient, wherein the syrup has a solids content of at least about 33% by weight based on the total weight of the syrup composition, and wherein the syrup composition has a caloric content of less than about 8 kcals per teaspoon.

### CROSS-REFERENCE TO RELATED APPLICATIONS

This application claims the benefit of priority from U.S. Provisional Patent Application No. 61/1016,927, filed on Dec. 27, 2007, the content of which is incorporated by reference.

### BACKGROUND OF THE INVENTION

1. Field of the Invention

The present invention relates to syrup compositions. More particularly, the present invention relates to low calorie syrup compositions containing a natural syrup and a soluble food ingredient.

2. Related Background Art

In the past, a low calorie syrup has been made by reducing the solids content of the syrup composition, which in turn reduces the caloric content. In most cases, all of the solids were removed. Gums were added to create texture, and natural or artificial flavors were added to create or enhance the composition's flavor. Additionally, high intensity sweeteners were typically added to adjust the sweetness of the syrup.

However, syrups made in this manner have many undesirable attributes. For example, these gum based low calorie syrups have an unnatural mouth feel (e.g., they are slimmy, gummy, or thin), minimal aroma, and do not taste like natural syrups.

### SUMMARY OF THE INVENTION

The present invention is directed to a syrup composition comprising a natural syrup and a soluble food ingredient, wherein the syrup has a solids content of at least about 33% by weight based on the total weight of the syrup composition, and wherein the syrup composition has a caloric content of less than about 8 kcals per teaspoon.

The present invention includes a method of making a syrup composition comprising the steps of (a) providing a natural syrup; (b) concentrating the natural syrup, thereby forming a concentrated syrup with a solids content of at least about 33% by weight based on the total weight of the syrup composition; and (c) combining the concentrated syrup with a soluble food ingredient, thereby forming the syrup composition, wherein the syrup composition has a caloric content of less than about 8 kcals per teaspoon.

Alternatively, the inventive syrup composition may be made by the method comprising the steps of (a) providing a natural syrup; (b) combining the natural syrup with a soluble food ingredient; (c) concentrating the natural syrup and the soluble food ingredient mixture, thereby forming the syrup composition, wherein the syrup composition has a solids content of at least about 33% by weight based on the total weight of the syrup composition; and wherein the syrup composition has a caloric content of less than about 8 kcals per teaspoon.

### DETAILED DESCRIPTION OF THE INVENTION

As used herein, the term “high intensity sweetener” means a substance that provides a high sweetness per unit mass compared to a nutritive sweetener and provides little or no nutritive value. Many high intensity sweeteners are known to those skilled in the art and any may be used in the present invention. Examples of high intensity sweeteners useful in the present invention include, for example, aspartame, acesulfame, alitame, brazzein, cyclamic acid, dihydrochalcones, extract of Dioscoreophyllum cumminsii, extract of the fruit of Pentadiplandra brazzeana, glycyrrhizin, hernandulcin, monellin, mogroside, neotame, neohesperidin, saccharin, sucralose, extracts of sweet plants, such as stevia, thaumatin, salts, and combinations thereof. A preferred high intensity sweetener according to the present invention is sucralose.

As used herein, the term “sugar alcohol” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, “modified starches” include starches that have been modified by crosslinking, chemically modified for improved stability, or physically modified for improved solubility properties. As used herein, “pre-gelatinized starches” or “instantized starches” refers to modified starches that have been pre-wetted, then dried to enhance their cold-water solubility. Suitable modified starches are commercially available from several suppliers such as, for example, A.E. Staley Manufacturing Company, and National Starch & Chemical Company. One suitable modified starch includes the pre-gelatinized waxy maize derivative starches that are commercially available from National Starch & Chemical Company under the tradenames, “Purity Gum” and “FilmSet,” and derivatives, copolymers, and mixtures thereof. Such waxy maize starches typically contain, based upon the total weight of the starch, from about 0 percent to about 18 percent of amylose and from about 100 percent to about 88 percent of amylopectin.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “aroma” means any food-grade volatile substance that may be employed to produce a desired scent, for example, when mixed with a foodstuff. Aromas useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone (juniper, common sage, Nootka cypress, and wormwood), thymol (camphor-like), trimethylamine (fish), vanillin (vanilla), and combinations thereof. Preferred aroma components according to the present invention include, essential oils (citrus oil), expressed oils (orange oil), distilled oils (rose oil), extracts (fruits), benzaldehyde, d-limonene, furfural, menthol, methyl butanoate, pentyl butanoate, salts, derivatives, and combinations thereof.

As used herein, a gram (or other given amount) of Sucrose Equivalent Sweetness (“SES”) means the amount of high intensity sweetener needed to be added to an 8 ounce glass of water in order to provide the same sweetness as an independent 8 ounce glass of water containing one gram (or the other given amount) of sucrose. For example, 1/200 g of aspartame will equal about one gram of SES because aspartame is about 200 times sweeter than sucrose. Similarly, about 1/500 g to about 1/600 g of sucralose will provide one gram of SES because sucralose is about 500 to about 600 times sweeter than sucrose.

“Water soluble” as used herein in connection with non-polymeric materials, shall mean from sparingly soluble to very soluble, i.e., not more than 100 parts water required to dissolve 1 part of the non-polymeric, water soluble solute. See Remington, “The Science and Practice of Pharmacy,” pages 208-209 (2000), which is incorporated by reference herein. “Water soluble” as used herein in connection with polymeric materials, shall mean that the polymer swells in water and can be dispersed at the molecular level to form a homogeneous dispersion.

The present invention is directed to a syrup composition comprising a natural syrup and a soluble food ingredient. The syrup composition has a solids content of at least about 33% by weight based on the total weight of the syrup composition. Moreover, the syrup composition has a caloric content of less than about 8 kcals per teaspoon.

Advantageously, the inventive syrup composition has many beneficial attributes over prior syrup compositions, including an improved and more natural taste, better texture, a more aesthetically appealing appearance, and better aroma.

Natural syrups are syrups derived from nature. In the syrup composition of the invention, the natural syrup serves as a base ingredient. Fruit syrups, tree syrups, bee syrups, tuber syrups, grass syrups and mixtures of these exemplify such natural syrups. Additionally, natural syrups include, for example, almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, maple syrup, apple syrup, blackberry syrup, pineapple syrup, honey, sugarcane syrup, and combinations thereof.

The natural syrup is present in an amount from about 1 weight percent (wt. %) to about 99 wt. %, based on the total weight of the syrup composition. Preferably, the natural syrup is about 5 wt. % to about 95 wt.%, more preferably, about 10 wt. % to about 90 wt. %, and most preferably, about 12 wt. % to about 88 wt. %, based on the total weight of the syrup composition.

Another essential ingredient in the syrup composition of the present invention is a soluble food ingredient. The soluble food ingredient is included in the syrup composition and serves among other things, as a bulking agent. In general, the soluble food ingredient is a carbohydrate. The soluble food ingredient may be, for example, a fructooligosaccharide (FOS), a digestion resistant maltodextrin (e.g., FiberSol), erythritol, inulin, a sugar polymer, or any combination thereof. Preferably, the soluble food ingredient is a fiber.

The soluble food ingredient is included in the syrup composition in an amount from about 0.05 wt. % to about 30 wt. %, based on the total weight of the syrup composition. Preferably, the soluble food ingredient is about 0.1 wt. % to about 20 wt. %, and more preferably, about 0.5 wt. % to about 10 wt. %, based on the total weight of the syrup composition.

An important aspect of the low calorie syrup composition is that it has a solids content (on a weight percentage basis) of at least about 25%, preferably, at least about 33%. Alternatively, the solids content of the syrup composition is about 25% to about 50%, more preferably, about 30% to about 40%, and even more preferably, about 33% to about 36%.

In addition, the reduced calorie syrup of the present invention has less than about 8 kcals per teaspoon (tsp). Preferably, less than about 6 kcals/tsp, more preferably, less than about 5 kcals/tsp. In one embodiment, the compositions of the present invention can have from about 1 to about 12 kcals per teaspoon of SES.

Alternatively, the reduced calorie syrup of the present invention has less than about 4 kcals per gram sucrose equivalent sweetness (SES). Preferably, less than about 3 kcal/SES, more preferably, less than about 2 kcal/SES.

The reduced calorie syrup of the present invention is more than about 33 weight percent (wt. %) solids. Preferably, more than about 40 wt. % solids, even more preferably, more than about 50 wt. % solids.

The reduced calorie syrup of the present invention has a syrup content that is less than about 33 wt. % syrup. Preferably, less than about 30 wt. % syrup, and more preferably, less than about 20 wt. % syrup.

Optionally, a variety of ingredients may he included in the low calorie syrup composition of the present invention.

Suitable “heat-stable, high-intensity sweeteners” include chemical compounds or mixtures of compounds, which elicit a sweet taste at least five times sweeter than sucrose, as measured in accordance with the test method described in G.B. Patent No. 1,543,167, which is incorporated by reference herein. Typically such sweeteners are substantially free from degradants after being heated for about one hour at about 40° C. Examples of such suitable sweeteners include, but are not limited to, sucralose, neotame, saccharin, acesulfame-K, cyclamate, neohesperdine DC, stevia, thavmatin, brazzein, aspartame, and mixtures thereof.

High intensity sweeteners are well known alternatives to nutritive sweeteners. They provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, for example, sucralose, are not absorbed when ingested and are, therefore, non-nutritive sweeteners.

Often the makers or users of these sweeteners add other components to them to overcome a less pleasant taste, e.g., a bitter taste. For example, cream of tartar may be added to saccharin to offset its bitterness; and 2,4-dihydroxybenzoic acid may be added to sucralose to control lingering sweetness.

Sucralose, which is also known as 4,1,6′-trideoxy-galactosucrose, is a heat-stable, high-intensity sweetener that may be produced in accordance with the process disclosed in U.K. Patent No. 1,544,167, and U.S. Pat. Nos. 5,136,031 and 5,498,709, which are incorporated by reference herein.

Neotame which is also known as N-(N-(3,3-dimethylbutyl)-L-a-aspartyl)-L-phenylalanine 1 methyl ester, a derivative of the dipeptide composed of the amino acids, aspartic acid and phenylalanine, is a heat-stable, high-intensity sweetener which was approved for use in the United States, July 2002 and is commercially available from The NutraSweet® Company.

Stevia is a non-caloric natural sweetener from the plant Stevia rebaudiana bertoni. The plant makes a number of sweet compounds collectively referred to as steviol glycosides, which make stevia 300 times sweeter than sucrose. These glycosides can be extracted from the plant with water and other solvents well known to those skilled in the art. They are heat stable, pH stable, do not ferment, and do not induce a glycemic response.

Stevioside, sometimes referred to as stevia, (13-[(2-O-β-D-glucopyranosyl)oxy]-kaur-16-en-18-oic acid-4α-β-D-glucopyranosyl ester) and rebaudioside A are exemplary glycosides of the diterpene derivative steviol, extracted and refined from Stevia rebaudiana bertoni (also known as eupatorium rebaudianum bertoni) leaves. These glycosides are high intensity sweeteners, about 100 to about 500 times that of sucrose, but have metallic and bitter notes. They can be used in a wide range of low or reduced calorie food products and beverages.

Other sweet glycosides can also be extracted from Stevia rebaudiana. These have varying degrees of sweetness. As used herein “stevia extract” means a sweet glycoside extracted from a stevia plant.

Of the glycosides found in stevia extracts, rebaudioside A is known to have the least aftertaste. This aftertaste described by many as bitter and licorice like, which is present in all current stevia extracts.

Like with all high intensity sweetener containing sweetener compositions, stevia containing sweetener compositions typically have been provided with a bulking agent to aid in measurement and distribution into the users application. Among those disclosed or used include fructooligosaccharide (FOS) and other fibers, maltodextrins, and erythritol. Erythritol is especially popular as it can mitigate some of the bitter taste.

The high intensity sweetener may be included in the syrup composition in an amount from about 0.05 wt. % to about 25 wt. %, based on the total weight of the syrup composition. Preferably, the high intensity sweetener is about 0.1 wt. % to about 15 wt. %, and more preferably, about 0.5 wt. % to about 10 wt. %, based on the total weight of the syrup composition.

Any coloring agent suitable for use in a food product may be used in the present invention and may include, but not be limited to azo dyes, quinopthalone dyes, triphenylmethane dyes, xanthene dyes, indigoid dyes, iron oxides, iron hydroxides, titanium dioxide, natural dyes, and mixtures thereof. More specifically, suitable colorants include, but are not limited to patent blue V, acid brilliant green BS, red 2G, azorubine, ponceau 4R, amaranth, D&C red 33, D&C red 22, D&C red 26, D&C red 28, D&C yellow 10, FD&C yellow 5, FD&C yellow 6, FD&C red 3, FD&C red 40, FD&C blue 1, FD&C blue 2, FD&C green 3, brilliant black BN, carbon black, iron oxide black, iron oxide red, iron oxide yellow, titanium dioxide, riboflavin, carotenes, antyhocyanines, turmeric, cochineal extract, clorophyllin, canthaxanthin, caramel, betanin, and mixtures thereof.

Vitamins and minerals may also be present.

Similarly, an acid may be included in the syrup composition in an amount from about 0.05 wt. % to about 30 wt. %, based on the total weight of the syrup composition. Preferably, the acid is about 0.1 wt. % to about 20 wt. %, and more preferably, about 0.5 wt. % to about 10 wt. %, based on the total weight of the syrup composition.

Suitable tapioca dextrins that may be used include those available from National Starch & Chemical Company under the tradename, “Crystal Gum” or “K-4484,” and derivatives thereof such as modified food starch derived from tapioca, which is available from National Starch and Chemical under the tradename, “Purity Gum 40,” and copolymers and mixtures thereof.

Examples of suitable fats include, but are not limited to hydrogenated vegetable oils such as cocoa butter, hydrogenated palm kernel oil, hydrogenated cottonseed oil, hydrogenated sunflower oil, and hydrogenated soybean oil; free fatty acids and salts thereof; and mixtures thereof.

The compositions can contain other components, including flavor, aroma, other nutritional component, binders, and mixtures thereof.

### METHODS OF MAKING

The present invention includes a method of making a syrup composition comprising the steps of (a) providing a natural syrup; (b) concentrating the natural syrup, thereby forming a concentrated syrup with a solids content of at least about 33% by weight based on the total weight of the syrup composition; and (c) combining the concentrated syrup with a soluble food ingredient, thereby forming the syrup composition, wherein the syrup composition has a caloric content of less than about 8 kcals per teaspoon.

Alternatively, the inventive syrup composition may be made by the method comprising the steps of (a) providing a natural syrup; (b) combining the natural syrup with a soluble food ingredient; (c) concentrating the natural syrup and the soluble food ingredient mixture, thereby forming the syrup composition, wherein the syrup composition has a solids content of at least about 33% by weight based on the total weight of the syrup composition; and wherein the syrup composition has a caloric content of less than about 8 kcals per teaspoon.

Compositions of the present invention can be made by any method known to those skilled in the art that provide homogenous even or homogeneous mixtures of the ingredients. These methods include dry blending, spray drying, agglomeration, wet granulation, compaction, co-crystalization and the like.

The following examples are provided to further illustrate the compositions and methods of the present invention. These examples are illustrative only and are not intended to limit the scope of the invention in any way.

### EXAMPLE 1

Low Calorie Agave Syrup - A

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 55.00 | | | | | | | | 18.00 | 3.06 | |
| Agave | 67% | 110.00 | | 24% | 4.00 | 440.00 | 1.10 | 121.00 | | 180.00 | 0.61 | 0.61 |
| Fos | | 345.00 | 45% | 76% | 1.50 | 517.50 | 0.10 | 34.50 | 345.00 | 420.00 | 0.82 | 0.82 |
| Water | | 250.00 | 33% | | | | | | | 18.00 | 13.89 | |
| Reb-a | | 0.75 | 0% | 0.16% | 4.00 | 3.00 | 350.00 | 262.50 | | 1000.00 | 0.00 | 0.00 |
| Total | | 760.75 | 100% | | | 960.50 | | 418.00 | 345.00 | | 18.38 | |
| Solids | | 455.75 | 60% | 100% | | | | | | | 1.43 | |
| Water | | 305.00 | 40% | | | | | | ~moles | | 4.70 | |
| | | | | | | | | | solids/l | | | |
| | | | | | | 1.26 | | G SES/g | G fibers/g | | | |
| | | | | | | | | 0.55 | 6.45 | | | |
| | | | | | | | | G SES/tsp | G fibers/tsp | | | |
| | | | | | | | | 2.20 | 1.81 | | | |
| | | | | | | | | Mg reb-a/tsp | Kcal/g SES | | | |
| | | | | | | | | 3.94 | 2.3 | | | |
| | | | | | | | | | Kcal/tsp | | | |
| | | | | | | | | | 5.05 | | | |

### EXAMPLE 2

Low Calorie Agave Syrup - B

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 55.00 | | | | | | | | 18.00 | 3.06 | |
| Agave | 67% | 110.00 | | 24% | 4.00 | 440.00 | 1.10 | 121.00 | | 180.00 | 0.61 | 0.61 |
| Fos | | 345.00 | 38% | 76% | 1.50 | 517.50 | 0.10 | 34.50 | 345.00 | 420.00 | 0.82 | 0.82 |
| Sucrose | | | 0% | 0% | 4.00 | | 1.00 | | | 360.00 | | |
| Water | | 400.00 | 44% | | | | | | | 18.00 | 22.22 | |
| Reb-a | | 1.00 | 0% | 0.22% | 4.00 | 4.00 | 350.00 | 350.00 | | 1000.00 | 0.00 | 0.00 |
| Total | | 911.00 | 100% | | | 961.50 | | 505.50 | 345.00 | | 26.71 | |
| Solids | | 456.00 | 50% | 100% | | | | | | | 1.43 | |
| Water | | 455.00 | 50% | | | | | | ~moles | | 3.15 | |
| | | | | | | | | | solids/l | | | |
| | | | | | | 1.06 | | G SES/g | G fibers/g | | | |
| | | | | | | | | 0.55 | 0.38 | | | |
| | | | | | | | | G SES/tsp | G fibers/tsp | | | |
| | | | | | | | | 2.22 | 1.51 | | | |
| | | | | | | | | Mg reb-a/tsp | Kcal/g SES | | | |
| | | | | | | | | 4.39 | 1.9 | | | |
| | | | | | | | | | Kcal/tsp | | | |
| | | | | | | | | | 4.22 | | | |

### EXAMPLE 3

Low Calorie Agave Syrup - C (prophetic)

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 55.00 | | | | | | | | 18.00 | 3.06 | |
| Agave | 67% | 110.00 | | 24% | 4.00 | 440.00 | 1.10 | 121.00 | | 130.00 | 0.61 | 0.61 |
| Fos | | 345.00 | 38% | 76% | 1.50 | 517.50 | 0.10 | 34.50 | 345.00 | 420.00 | 0.82 | 0.82 |
| sucrose | | | 0% | 0% | 4.00 | | 1.00 | | | 360.00 | | |
| Water | | 400.00 | 44% | | | | | | | 18.00 | 22.22 | |
| Reb-a | | 1.46 | 0% | 0.32% | 4.00 | 5.83 | 350.00 | 509.85 | | 1000.00 | 0.00 | 0.00 |
| Total | | 911.46 | 100% | | | 963.33 | | 665.35 | 345.00 | | 26.71 | |
| Solids | | 456.46 | 50% | 100% | | | | | | | 1.43 | |
| Water | | 455.00 | 50% | | | | | | ~moles | | 3.15 | |
| | | | | | | | | | solids/l | | | |
| | | | | | | 1.06 | | G SES/g | G fibers/g | | | |
| | | | | | | | | 0.73 | 0.38 | | | |
| | | | | | | | | G SES/tsp | G fibers/tsp | | | |
| | | | | | | | | 2.92 | 1.51 | | | |
| | | | | | | | | Mg reb-a/tsp | Kcal/g SES | | | |
| | | | | | | | | 6.39 | 1.45 | | | |
| | | | | | | | | | Kcal/tsp | | | |
| | | | | | | | | | 4.23 | | | |

### EXAMPLE 4

Reference #1 (agave nectar)

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | balch | solids |
| Water | 33% | 55.00 | | | | | | | | 18.00 | 3.06 | |
| Agave | 67% | 110.00 | | 100% | 4.00 | 440.00 | 1.10 | 121.00 | | 180.00 | 0.61 | 0.61 |
| Fos | | | 0% | 0% | 1.50 | | 0.10 | | | 420.00 | | |
| Sucrose | | | 0% | 0% | 4.00 | | 1.00 | | | 360.00 | | |
| Water | | | 0% | | | | | | | 18.00 | | |
| Reb-a | | | 0% | 0.00% | 4.00 | | 350.00 | | | 1000.00 | | |
| Total | | 165.00 | 100% | | | 440.00 | | 121.00 | | | 3.67 | |
| Solids | | 110.00 | 67% | 100% | | | | | | | 0.61 | |
| Water | | 55.00 | 33% | | | | | | ~moles | | 11.11 | |
| | | | | | | | | | solids/l | | | |
| | | | | | | 2.67 | | G SES/g | G fibers/g | | | |
| | | | | | | | | 0.73 | | | | |
| | | | | | | | | G SES/tsp | G fibers/tsp | | | |
| | | | | | | | | 2.93 | | | | |
| | | | | | | | | Mg reb-a/tsp | Kcal/g SES | | | |
| | | | | | | | | | 3.64 | | | |
| | | | | | | | | | Kcal/tsp | | | |

### EXAMPLE 5

Low Calorie Maple Syrup - A

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 60.00 | | | | | | | | 18.00 | 3.33 | |
| Maple | 67% | 120.00 | | 26% | 4.00 | 480.00 | 0.90 | 108.00 | | 180.00 | 0.67 | 0.67 |
| Fibersol 2 | | 350.00 | 38% | 74% | 1.50 | 525.00 | 0.10 | 35.00 | 350.00 | 420.00 | 0.83 | 0.83 |
| sucrose | | | 0% | 0% | 4.00 | | 1.00 | | | 360.00 | | |
| Water | | 400.00 | 43% | | | | | | | 18.00 | 22.22 | |
| Reb-a | | 0.50 | 0% | 0.11% | 4.00 | 2.00 | 350.00 | 175.00 | | 1000.00 | 0.00 | 0.00 |
| Total | | 930.50 | 100% | | | 1007.00 | | 318.00 | 350.00 | | 27.06 | |
| Solids | | 470.50 | 51% | 100% | | | | | | | 1.50 | |
| Water | | 460.00 | 49% | | | | | | ~moles | | 3.26 | |
| | | | | | | | | | solids/l | | | |
| | | | | | | 1.08 | | G SES/g | G fibers/g | | | |
| | | | | | | | | 0.34 | 0.38 | | | |
| | | | | | | | | G SES/tsp | G fibers/tsp | | | |
| | | | | | | | | 1.37 | 1.50 | | | |
| | | | | | | | | Mg reb-a/tsp | Kcal/g SES | | | |
| | | | | | | | | 2.15 | 3.17 | | | |
| | | | | | | | | | Kcal/tsp | | | |
| | | | | | | | | | 4.33 | | | |

### EXAMPLE 6

Low Calorie Maple Syrup - B (prophetic)

| | | | % Of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 60.00 | | | | | | | | 18.00 | 3.33 | |
| Maple | 67% | 120.00 | | 25% | 4.00 | 480.00 | 0.90 | 108.00 | | 180.00 | 0.67 | 0.67 |
| Fibersol 2 | | 350.00 | 38% | 74% | 1.50 | 525.00 | 0.10 | 35.00 | 350.00 | 420.00 | 0.83 | 0.83 |
| sucrose | | | 0% | 0% | 4.00 | | 1.00 | | | 360.00 | | |
| Water | | 400.00 | 43% | | | | | | | 18.00 | 22.22 | |
| Reb-a | | 0.66 | 0% | 0.14% | 4.00 | 2.62 | 350.00 | 229.25 | | 1000.00 | 0.00 | 0.00 |
| Total | | 930.66 | 100% | | | 1007.62 | | 372.25 | 350.00 | | 27.06 | |
| Solids | | 470.66 | 51% | 100% | | | | | | | 1.50 | |
| Water | | 460.00 | 49% | | | | | | ~moles | | 3.26 | |
| | | | | | | | | | solids/l | | | |
| | | | | | | 1.08 | | G SES/g | G fibers/g | | | |
| | | | | | | | | 0.40 | 0.38 | | | |
| | | | | | | | | G SES/tsp | G fibers/tsp | | | |
| | | | | | | | | 1.60 | 1.50 | | | |
| | | | | | | | | Mg reb-a/tsp | Kcal/g SES | | | |
| | | | | | | | | 2.82 | 2.71 | | | |
| | | | | | | | | | Kcal/tsp | | | |
| | | | | | | | | | 4.33 | | | |

### EXAMPLE 7

Low Calorie Maple Syrup - C (prophetic)

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 60.00 | | | | | | | | 18.00 | 3.33 | |
| Maple | 67% | 120.00 | | 26% | 4.00 | 480.00 | 0.90 | 108.00 | | 180.00 | 0.67 | 0.67 |
| Fibersol 2 | | 350.00 | 38% | 74% | 1.50 | 525.00 | 0.10 | 35.00 | 350.00 | 420.00 | 0.83 | 0.83 |
| Sucrose | | | 0% | 0% | 4.00 | | 1.00 | | | 360.00 | | |
| Water | | 400.00 | 43% | | | | | | | 18.00 | 22.22 | |
| Sucralose | | 0.35 | 0% | 0.07% | 4.00 | 1.40 | 600.00 | 210.00 | | 1000.00 | 0.00 | 0.00 |
| Total | | 930.35 | 100% | | | 1006.40 | | 353.00 | 350.00 | | 27.06 | |
| Solids | | 470.35 | 51% | 100% | | | | | | | 1.50 | |
| Water | | 460.00 | 49% | | | | | | ~moles | | 3.26 | |
| | | | | | | | | | solids/l | | | |
| | | | | | | 1.08 | | G SES/g | G fibers/g | | | |
| | | | | | | | | 0.38 | 0.38 | | | |
| | | | | | | | | G SES/tsp | G fibers/tsp | | | |
| | | | | | | | | 1.52 | 1.50 | | | |
| | | | | | | | | Mg reb-a/tsp | Kcal/g SES | | | |
| | | | | | | | | | 2.85 | | | |
| | | | | | | | | | Kcal/tsp | | | |
| | | | | | | | | | 4.33 | | | |

### EXAMPLE 8

Reference 2 (Maple Syrup)

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | mw | batch | solids |
| Water | 33% | 60.00 | | | | | | | | 18.00 | 3.33 | |
| Maple | 67% | 120.00 | | 100% | 4.00 | 480.00 | 0.90 | 108.00 | | 180.00 | 0.67 | 0.67 |
| Fibersol 2 | | | 0% | 0% | 1.50 | | 0.10 | | | 420.00 | | |
| sucrose | | | 0% | 0% | 4.00 | | 1.00 | | | 360.00 | | |
| Water | | | 0% | | | | | | | 18.00 | | |
| Reb-a | | | 0% | 0.00% | 4.00 | | 350.00 | | | 1000.00 | | |
| Total | | 180.00 | 100% | | | 480.00 | | 108.00 | | | 4.00 | |
| Solids | | 120.00 | 67% | 100% | | | | | | | 0.67 | |
| Water | | 60.00 | 33% | | | | | | ~moles | | 11.11 | |
| | | | | | | | | | solids/l | | | |
| | | | | | | 2.67 | | G SES/g | G fibers/g | | | |
| | | | | | | | | 0.60 | | | | |
| | | | | | | | | G SES/tsp | G fibers/tsp | | | |
| | | | | | | | | 2.40 | | | | |
| | | | | | | | | Mg reb-a/tsp | Kcal/g SES | | | |
| | | | | | | | | | 4.44 | | | |
| | | | | | | | | | Kcal/tsp | | | |
| | | | | | | | | | 10.67 | | | |

### EXAMPLE 9

Low Calorie Honey

| | | | % of | % of | Kcals/ | Kcal/ | | SES/ | | | Moles/ | Moles |
|---|---|---|---|---|---|---|---|---|---|---|---|---|
| | | grams | totals | solids | grams | batch | SES | batch | fiber | row | batch | solids |
| Water | 33% | 20.00 | | | | | | | | 18.00 | 1.11 | |
| Honey | 67% | 40.00 | | 34% | 4.00 | 160.00 | 1.10 | 44.00 | | 180.00 | 0.22 | 0.22 |
| Fos | | 75.00 | 25% | 64% | 1.50 | 112.50 | 0.10 | | 75.00 | 420.00 | 0.18 | 0.18 |
| Starch | | 1.00 | 0% | 1% | 4.00 | 4.00 | 1.00 | 7.50 | | 360.00 | | |
| Water | | 165.00 | 55% | | | | | | | 18.00 | 9.17 | |
| Reb-a | | 0.35 | 0% | 0.30% | 4.00 | 1.4 | 350.00 | 122.50 | | 1000.00 | 0.00 | 0.00 |
| Total | | 301.35 | 100% | | | 277.90 | | 174.00 | 75.00 | | 10.68 | |
| Solids | | 116.35 | 39% | 100% | | | | | | | 0.40 | |
| Water | | 185.00 | 61% | | | | | | ~moles | | 2.18 | |
| | | | | | | | | | solids/l | | | |
| | | | | | | 0.92 | | G SES/g | G fibers/g | | | |
| | | | | | | | | 0.58 | 0.25 | | | |
| | | | | | | | | G SES/tsp | G fibers/tsp | | | |
| | | | | | | | | 2.31 | 1.00 | | | |
| | | | | | | | | Mg reb-a/tsp | Kcal/g SES | | | |
| | | | | | | | | 4.65 | 1.60 | | | |
| | | | | | | | | | Kcal/tsp | | | |
| | | | | | | | | | 3.69 | | | |

The samples are judged to be equi-sweet.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed:

1. A syrup composition comprising:
a natural syrup; and
a soluble food ingredient;
wherein the syrup has a solids content of at least about 33% by weight based on the total weight of the syrup composition, and
wherein the syrup composition has a caloric content of less than about 8 kcals per teaspoon.

2. The syrup composition of claim 1, wherein the natural syrup is selected from the group consisting of fruit syrups, tree syrups, bee syrups, tuber syrups, grass syrups and mixtures thereof.

3. The syrup composition of claim 1, wherein the natural syrup is selected from the group consisting of almond syrup, banana syrup, blueberry syrup, cherry syrup, coconut syrup, hazelnut syrup, kiwi syrup, lemon syrup, mango syrup, orange syrup, peach syrup, strawberry syrup, vanilla syrup, raspberry syrup, maple syrup, apple syrup, blackberry syrup, pineapple syrup, honey, sugarcane syrup, and mixtures thereof.

4. The syrup composition of claim 1, wherein the soluble food ingredient is a carbohydrate.

5. The syrup composition of claim 1, wherein the soluble food ingredient is selected from the group consisting of fructooligosaccharide, a digestion resistant maltodextrin, erythritol, inulin, a sugar polymer, and combinations thereof.

6. The syrup composition of claim 1, wherein the soluble food ingredient is a fiber.

7. The syrup composition of claim 1, wherein the solids content of the syrup composition is at least about 40% by weight based on the total weight of the syrup composition.

8. The syrup composition in claim 1, further comprising a high intensity sweetener.

9. The syrup composition in claim 8, wherein the high intensity sweetener is selected from the group consisting of neotame, saccharin, acesulfame-K, cyclamate, neohesperdine DC, thavmatin, brazzein, aspartame, and mixtures thereof.

10. The syrup composition of claim 8, wherein the caloric content of the syrup composition is less than about 4 kcals per gram sucrose equivalent sweetness.

11. A method of making a syrup composition comprising the steps of:
(a) providing a natural syrup;
(b) concentrating the natural syrup, thereby forming a concentrated syrup with a solids content of at least about 33% by weight based on the total weight of the syrup composition; and
(c) combining the concentrated syrup with a soluble food ingredient, thereby forming the syrup composition,
wherein the syrup composition has a caloric content of less than about 8 kcals per teaspoon.

12. A method of making a syrup composition comprising the steps of:
(a) providing a natural syrup;
(b) combining the natural syrup with a soluble food ingredient;
(c) concentrating the natural syrup and the soluble food ingredient mixture, thereby forming the syrup composition,
wherein the syrup composition has a solids content of at least about 33% by weight based on the total weight of the syrup composition; and
wherein the syrup composition has a caloric content of less than about 8 kcals per teaspoon.
